(19) United States
(12) Patent Application Publication
(10) Pub. No.: US 2009/0208720 A1
(43) Pub. Date: Aug. 20, 2009

(54) POLYBUTYLENE TEREPHTHALATE RESIN COMPOSITION

(75) Inventors: Yasumitsu Miyamoto, Shizuoka (JP); Akira Nakai, Shizuoka (JP)

Correspondence Address: BUCHANAN, INGERSOLL & ROONEY PC, POST OFFICE BOX 1404, ALEXANDRIA, VA, 22313-1404, US

(73) Assignee: WinTech Polymer Ltd., Tokyo (JP)

(21) Appl. No.: 12/309,686

(22) PCT Filed: Dec. 18, 2007
(86) PCT No.: PCT/JP2007/074768

§ 371 Date: Jan. 27, 2009

(30) Foreign Application Priority Data
Dec. 19, 2006 (JP) 2006-340988

(51) Int. Cl. C08L 67/00; B32B 27/32; B32B 27/36

(52) U.S. Cl. 428/220; 524/539; 525/190

(57) ABSTRACT

Provided is a polybutylene terephthalate resin composition maintaining mechanical strength while providing excellent toughness, and which has excellent flowability during melt molding. In particular, to 100 parts by weight of the sum of 50 to 99 parts by weight of (A) a polybutylene terephthalate resin and 1 to 50 parts by weight of (B) a thermoplastic elastomer, there is added 0.01 to 5 parts by weight of (C) an acrylic-based oligomer.

### TECHNICAL FIELD

The present invention relates to a polybutylene terephthalate resin composition having excellent toughness and flowability, and more particularly to a polybutylene terephthalate resin composition having excellent toughness and flowability, and being suitable for electrical and electronic parts such as a connector, a switch, a capacitor, an integrated circuit (IC), a relay, a resistor, alight-emitting diode (LED), a coil bobbin, and peripheral devices thereof, and housings thereof.

### BACKGROUND ART

A polybutylene terephthalate resin is widely used in various applications, as engineering plastics, such as automobile parts, and electrical and electronic parts owing to their excellent mechanical characteristics, electrical characteristics, heat resistance, weather resistance, water resistance, chemical resistance, and solvent resistance. With the increasing and diversifying use of a polybutylene terephthalate resin, however, it is often requested to have further high performance and specialty, thus being desired to have further excellent mechanical properties, specifically toughness such as flexibility and impact resistance. In order to meet such requirements, there have been proposed methods and the like for mixing a polybutylene terephthalate resin with a thermoplastic elastomer such as olefin-based polymer or polyester-based polymer. Furthermore, in recent years, there have been strongly requested miniature molded articles having complex shapes, and thus there have been often requested to further improve the flowability in the molten state in order to improve the molding workability, as well as the above mechanical properties.

For example, JP 10-95907 A describes a resin composition prepared by mixing a polybutylene terephthalate resin with an acrylic-based core-shell polymer and/or a polyester-based elastomer, and filler, which mixture suppresses separation phenomena of surface layers on the molded article while maintaining toughness and rigidity. The disclosure, however, does not specifically give description about the improvement in the flowability.

A method of improving the flowability is disclosed in JP-A 61-85467, which improvement is attained by adding an aromatic polybasic acid ester to a polyester resin. Another method of improving the flowability is disclosed in JP 62-20737 A, by adding an ethylene polymer or an ethylene copolymer to a polyester resin. Although these methods are effective, they are requested to further improve the flowability, and often requested to secure a certain level of strength.

In JP-A 5-179114, there is proposed a method of blending polybutylene terephthalates having different viscosities from each other. The method, however, is inherently inferior in the elongation of the resin to that of the single use of high viscosity polybutylene terephthalate.

Other than the above, the use of a flowability-improving agent for resins is a common practice. In this method, however, there are concerns about exudation and separation of surface layers of the molded article, and further the deterioration of the mechanical strength is unavoidable.

### DISCLOSURE OF THE INVENTION

The present invention provides a polybutylene terephthalate resin composition maintaining mechanical strength while providing excellent toughness, and having excellent flowability during melt molding.

To solve the above problems, the inventors of the present invention have conducted detail studies, and have found that the polybutylene terephthalate resin composition capable of achieving the above object can be attained by simultaneously using a polybutylene terephthalate resin and a thermoplastic elastomer, and further by adding an acrylic-based oligomer thereto, thereby having perfected the present invention.

That is, the present invention provides a polybutylene terephthalate resin composition, obtained by blending 0.01 to 5 parts by weight of (C) an acrylic-based oligomer to 100 parts by weight of the sum of 50 to 99 parts by weight of (A) a polybutylene terephthalate resin and 1 to 50 parts by weight of (B) a thermoplastic elastomer.

The present invention provides a thin-wall molded article composed of the above polybutylene terephthalate resin composition, giving a flow length of 40 mm or more at a thickness of 0.5 mm during the injection molding at a cylinder temperature of 260° C. and a mold temperature of 65° C.

The present invention provides applications of the above thin-wall molded article, being a switch, a capacitor, a connector, an integrated circuit (IC), a relay, a resistor, a light-emitting diode (LED), a coil bobbin, and peripheral devices or housings thereof. Alternatively, the present invention provides applications of a switch of the above thin-wall molded article, a capacitor, a connector, an integrated circuit (IC), a relay, a resistor, a light-emitting diode (LED), a coil bobbin, and peripheral devices or housings thereof.

### DETAIL DESCRIPTION OF THE INVENTION

The polybutylene terephthalate resin composition according to the present invention has excellent mechanical strength and toughness, and further has excellent flowability during melt molding. Owing to these characteristics, the polybutylene terephthalate resin composition according to the present invention is suitable for electrical and electronic parts such as a connector, a switch, a capacitor, an integrated circuit (IC), a relay, a resistor, a light-emitting diode (LED), a coil bobbin, and peripheral devices thereof, and housings thereof.

The individual structural components of the resin material according to the present invention are described in detail in the following. The (A) polybutylene terephthalate resin which is the base resin of the present invention is a polybutylene terephthalate prepared by polycondensation of terephthalic acid or ester-forming derivatives thereof with C4 alkylene glycol or ester-forming derivatives thereof. The polybutylene terephthalate may be a copolymer containing thereof by 70% by weight or more.

Examples of dibasic acid components other than terephthalic acid or ester-forming derivatives thereof (such as lower alcohol ester) are: aliphatic and aromatic polybasic acids or ester-forming derivatives thereof such as isophthalic acid, naphthalene dicarboxylic acid, adipic acid, sebacic acid, trimellitic acid, or succinic acid. Examples of glycol components other than 1,4-butane diol are: common alkylene alcohols such as ethylene glycol, diethylene glycol, propylene glycol, trimethylene glycol, hexamethylene glycol, neopentyl glycol, or cyclohexane dimethanol; a lower alkylene glycol such as 1,3-octane diol; aromatic alcohols such as bisphenol A or 4,4′-dihydroxybiphenyl; alkylene oxide adduct alcohols such as ethylene oxide 2 mole adduct of bisphenol A, or propylene oxide 3 mole adduct of bisphenol A; and polyhydroxy compounds such as glycerin or pentaerythritol, or ester-forming derivatives thereof.

According to the present invention, any of polybutylene terephthalates prepared by polycondensation of the above compounds as monomer components can be used as the (A) components of the present invention, and they can be used separately or in combination of two or more of them. Alternatively, a branched polymer belonging to copolymer can be used. The polybutylene terephthalate branched polymer referred herein represents a polyester prepared from what is called the polybutylene terephthalate monomer or the butylene terephthalate monomer, as a main component, while adding a polyfunctional compound to create a branched structure. Applicable polyfunctional compounds include trimesic acid, trimellitic acid, pyromellitic acid, alcohol esters thereof, glycerin, trimethylol ethane, trimethylol propane, and pentaerythritol.

The intrinsic viscosity (IV) of the (A) polybutylene terephthalate resin is not specifically limited, and is, for example, within the range of about 0.5 to 1.4 determined in o-chlorophenol at 35° C. From the viewpoint of hydrolysis resistance and extrusion workability, the IV is preferably within the range of about 0.6 to 1.3. If the IV is excessively low, the desired hydrolysis resistance and extrusion workability may not be attained. If the IV is excessively high, the load during extrusion working becomes heavy, and sufficient flowability may not be attained.

The (A) polybutylene terephthalate resin can be manufactured by a common method such as copolymerization (polycondensation) by, for example, ester interchange and direct esterification, using terephthalic acid or its ester-forming derivative with 1,4-butane diol, and if required, a copolymerizable monomer.

The (B) thermoplastic elastomer used in the present invention is not specifically limited, and any of known elastomers can be used. Examples of the (B) thermoplastic elastomers are polyester-based elastomer, olefin-based elastomer, polyvinyl acetate, fluororesin, urethane-based elastomer, amide-based elastomer, acrylate-based elastomer, styrene-based elastomer, fluorine-based elastomer, and butadiene-based elastomer. Furthermore, there can be used a core-shell type polymer structured by the core part composed of a rubber-like cross-linked body such as butyl acrylate, and by the shell part composed of a glass-like polymer such as methyl acrylate.

These (B) thermoplastic elastomers may be ones in which reactive groups such as epoxy group, isocyanate group, or amino group were introduced, or may be modified ones prepared by a known method such as cross-linkage or grafting. Polyester-based elastomer and olefin-based elastomer are preferably used as (B) thermoplastic elastomers.

The polyester-based elastomers can be grouped into polyether type and polyester type. Any of them can be used if only the flexural elastic modulus is 1000 MPa or less, preferably 700 MPa or less. If the flexural elastic modulus exceeds 1000 MPa, sufficient flexibility cannot be attained. The polyether-type polyester-based elastomer is a polyester elastomer composed of aromatic polyester as a hard segment, and composed of polyester consisting of oxyalkylene glycol polymer and dicarboxylic acid, as a soft segment. The aromatic polyester unit in the hard segment is a polycondensate of dicarboxylic acid compounds with dihydroxy compounds, a polycondensate of oxycarboxylic acid compounds, or a polycondensate of these three component compounds. For example, polybutylene terephthalate is used as the hard segment. As for the soft segment, a compound obtained by polycondensation of polyalkylene ethers with dicarboxylic acids is used. For example, there is used an esterified compound of polyoxytetramethylene glycol derived from tetrahydrofuran. The above-given polyether elastomers are commercially available as, for example: PERPREN P-30B, P-70B, P-90B, and P-280B, manufactured by Toyobo Co., Ltd.; Hytrel 4057, 4767, 6347, and 7247, manufactured by DuPont Toray Co., Ltd.; and Lite Flex 655 manufactured by Ticona Ltd.

The polyester-type polyester-based elastomer is a polyester elastomer composed of aromatic polyester as a hard segment, and composed of amorphous polyester as a soft segment. The aromatic polyester unit in the hard segment is identical to that in the above polyether-type polyester-based elastomer. The soft segment is a ring-opening polymer of lactone, that is to say, polylactone, or aliphatic polyester derived from aliphatic dicarboxylic acid and aliphatic diol. The polyester-type elastomers are commercially available as, for example, PELPRENE S-1002 and S-2002, manufactured by Toyobo Co., Ltd.

Preferable olefin-based elastomers are copolymers containing ethylene and/or propylene as components, such as ethylene-propylene copolymer, ethylene-butene copolymer, ethylene-octene copolymer, ethylene-propylene-butene copolymer, ethylene-propylene-diene copolymer, ethylene-ethylacrylate copolymer, ethylene vinyl acetate copolymer, and ethylene-glycidyl methacrylate copolymer, though not limited to them.

Furthermore, among the olefin-based elastomers, there can be applied a graft copolymer prepared by chemically bonding one or more of polymers or copolymers, structured by the repeating unit represented by the following general formula (1), in the branched or the cross-linked structure to (a-1) a copolymer of ethylene-unsaturated carboxylic alkyl ester or (a-2) an olefin-based copolymer composed of α-olefin and α,β-unsaturated acid glycidyl ester.

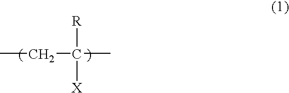

where, R is hydrogen or a lower alkyl group, X is one, two or more groups selected from —COOCH₃, —COOC₂H₅, —COOC₄H₉, —COOCH₂CH(C₂H₅)C₄H₉, —C₆H₅, and —CN.

The (B) thermoplastic elastomer is used within the range of 1 to 50 parts by weight, and preferably 5 to 40 parts by weight, to 100 parts by weight of the sum of (B) thermoplastic elastomer and (A) polybutylene terephthalate resin. If the content of the (B) thermoplastic elastomer is less than 1 part by weight to the sum of 100 parts by weight, the effect of improving the toughness is insufficient. If the content of the (B) thermoplastic elastomer exceeds 50 parts by weight thereto, the rigidity becomes insufficient, and thus satisfactory mechanical strength cannot be attained.

The (C) acrylic-based oligomer is an important structural component in the present invention in providing flowability and maintaining mechanical strength. A preferable acrylic-based oligomer is an oligomer of acrylic acid-based or methacrylic acid-based alkyl ester. Such polymer of acrylic acid-based or methacrylic acid-based alkylester may contain a monomer unit of other vinyl monomers such as α-olefins including ethylene, propylene and butane-1, styrene, acrylonitrile, vinyl acetate, butadiene, vinyl alcohol, maleic acid, fumaric acid, itaconic acid, and esters thereof.

The (C) acrylic-based oligomers are commercially available as, for example: FC-112, FC-113, and LS-3, manufactured by Adeka Corporation; UMB-1001, UMB-2005, and UT-2001, manufactured by Soken Chemical and Engineering Co., Ltd.; and UP-1050 and UH-2032, manufactured by Toagosei Co., Ltd.

The content of the (C) acrylic-based oligomer is within the range of 0.01 to 5 parts by weight, and preferably 0.05 to 3 parts by weight, to 100 parts by weight of the sum of (A) polybutylene terephthalate resin and (B) thermoplastic elastomer. If the content thereof is less than 0.01 parts by weight, the effect of improvement in the flowability is small. If the content thereof exceeds 5 parts by weight, the melting and kneading becomes difficult, and exudation, gas generation during molding working and the like likely occur even if the kneading can be attained, and thus there is a possibility that the adhesion of contaminants to the mold may be induced.

### (D) Inorganic Filler

The (D) inorganic filler used in the present invention is not specifically limited, and any known inorganic filler can be used. Examples of the inorganic fillers are: fibrous fillers such as glass fiber, graphite fiber, silica fiber, alumina fiber, boron fiber, feldspar, whisker of potassium titanate, or whisker of potassium borate; plate fillers such as mica or glass flake; and powder or granular fillers such as silica, glass bead, glass flake, glass bubble, kaolin, wollastonite, calcium silicate, or calcium carbonate. These fillers may be used alone or in combination of two or more of them. From the point of mechanical strength, heat resistance, and dimensional stability of the composition, glass fiber is particularly preferred.

The inorganic filler may be surface-treated, if required. Examples of the compounds used for the surface treatment are functional compounds such as epoxy-based compound, isocyanate-based compound, silane-based compound, or titanate-based compound. These compounds may be used by surface treatment of the inorganic filler in advance or may be added when materials are prepared.

In the resin composition according to the present invention, the content of (D) inorganic filler is within the range of 10 to 100 parts by weight, and preferably from 20 to 80 parts by weight, to the sum of (A) polybutylene terephthalate resin and (B) thermoplastic elastomer. If the content of (D) inorganic filler is less than 10 parts by weight, sufficient mechanical strength may not be attained. If the content thereof exceeds 100 parts by weight, sufficient flowability may not be attained.

The polybutylene terephthalate resin composition according to the present invention can be used as a composition, if required, to which one or more of other thermoplastic resins, additives, organic fillers, and the like are added as an auxiliary ingredient during or after polymerization, within the range not to deteriorate the mechanical strength, flexibility, and flowability during molding working.

Examples of the thermoplastic resins are polyester resin (such as polyethylene terephthalate) other than the (A) component, polystyrene-based resin, polyamide-based resin, polycarbonate, polyacetal, polyarylene oxide, polyarylene sulfide, and fluororesin.

Examples of the additives are known ones including: stabilizer such as UV-absorber and antioxidant; antistatic agent; fire-retardant (halogen-based fire retardant and non-halogen based fire retardant); fire-retardant assistant; coloring matter such as dye and pigment; lubricator; plasticizer; sliding agent; mold-releasing agent; and crystal nucleation agent.

The composition according to the present invention is easily prepared by a known apparatus and method commonly used as a conventional method for manufacturing resin compositions. For example, there can be applied any of (i) a method of mixing respective components, and of kneading and extruding the mixture through an extruder to form pellets, and then molding the pellets; (ii) a method of preparing a plurality kinds of pellets having different compositions from each other, and mixing the respective kinds of pellets at a certain ratio for molding, and after molding, obtaining molded articles having desired compositions; and (iii) a method of directly charging one, two or more of the plurality of components to a molding machine. A method of mixing and adding a part of resin components in a fine powder form to other components is a preferred one in terms of homogeneous mixing of these components. The above additives may be added at an arbitrary timing to obtain a desired composition.

As an indicator of flowability of the resin composition according to the present invention, there can be applied melt viscosity under constant piston-flow shear rate. Generally the Melt Index is adopted, which is determined under the condition of 235° C. and 2160 g of load, in accordance with ASTM D-1238. The Melt Index is, however, determined under a constant load, and thus piston-flow shear rate differs with resin. On the contrary, considering that actual injection molding is performed under constant piston-flow shear rate, the indicator of melt viscosity determination under constant piston-flow shear rate specified in ISO 11443 is considered to be one closer to the actual flow characteristics. For example, the measurement condition is 260° C., a capillary diameter of 1 mm and a length of 20 mm and a shear rate of 1000 sec⁻¹. The determined value is expressed by Pa·s unit. Lower value means superior flowability in the molten state and superior flowability during molding.

The resin composition according to the present invention gives good molding workability. As a result, there can be easily attained molded article by common molding methods such as extrusion and injection molding through melting and kneading of the above resin composition, and thus efficiently attained good molded article. Specifically injection molding is preferred.

### [Molded Article]

Since the resin composition according to the present invention has an excellent melt flowability as described above, the molding workability is good, and thus the resin composition is useful in manufacturing a molded article or product having a high mechanical strength and heat resistance.

In particular, the resin composition according to the present invention is suitable for manufacturing molded article having thin-wall portion. For example, in the injection molding at a cylinder temperature of 260° C. and a mold temperature of 65° C., which is ordinary manufacturing condition for injection molding of polybutylene terephthalate resin, the injection molding can provide a molded article having a portion of 0.5 mm or thinner wall in a part.

A molded article having a flow length of 40 mm or more at a wall thickness of 0.5 mm is sometimes required. In that case, the resin composition of the present invention can respond to a flow length of 40 mm or more.

That is, a preferred aspect of the present invention is the above polybutylene terephthalate having a flow length of 40 mm or more at a thickness of 0.5 mm during the injection molding at a cylinder temperature of 260° C. and a mold temperature of 65° C.

Examples of the thin-wall molded articles having a portion of 0.5 mm or less in a part thereof include a switch, a capacitor, a connector, an integrated circuit (IC), a relay, a resistor, a light-emitting diode (LED), a coil bobbin, and peripheral devices or housings thereof.

Since the polybutylene terephthalate resin composition according to the present invention has excellent toughness and flowability, it is suitable for the above-described varieties of electrical and electronic parts.

### EXAMPLES

The present invention is described in more detail in the following referring to examples. However, the present invention is not limited to these examples.

### Examples 1 to 12, and Comparative Examples 1 to 4

The respective resin compositions were dry-blended at the respective ratios given in Table 1, which blend was melted and kneaded in a twin-screw extruder with a screw diameter of 30 mm at 250° C. to form pellets. From the pellets, test pieces were prepared to give evaluations. The result is given in Table 1. Comparative Example 3 was not evaluated because of the difficulty in extrusion working.

The detail of applied components and the measurement methods for evaluating the physical properties are described below.

(A) Polybutylene Terephthalate

(A-1) Polybutylene terephthalate, intrinsic viscosity 0.69, manufactured by WinTech Polymer Ltd.

(A-2) Polybutylene terephthalate, intrinsic viscosity 0.875, manufactured by WinTech Polymer Ltd.

(B) Thermoplastic Elastomer

(B-1) PELPRENE S2002, manufactured by Toyobo Co., Ltd.

(B-2) PELPRENE GP300, manufactured by Toyobo Co., Ltd.

(B-3) NUC6096, manufactured by Nippon Unicar Co., Ltd.

(C) Acrylic-Based Oligomer

(C-1) ADEKA STAB FC112, manufactured by Adeka Corporation

(C-2) ACTOFLOW UMB2005, manufactured by Soken Chemical and Engineering Co., Ltd.

(C-3) ARUFON UH2032, manufactured by Toagosei Co., Ltd.

(D) Glass Fiber

ECS03T187, manufactured by Nippon Electric Glass Co., Ltd.

### <Melt Viscosity>

The prepared pellets were dried for 3 hours at 140° C. The melt viscosity of the pellets was determined in accordance with ISO 11443, using Capillograph 1B manufactured by Toyo Seiki Seisakusho, Ltd. at a capillary diameter of 1 mm and a length of 20 mm, a shear rate of 1000 sec⁻¹ and a furnace temperature of 260° C. Lower value means superior flowability in the molten state and superior flowability during molding.

### <Tensile Strength and Elongation>

The prepared pellets were dried for 3 hours at 140° C., which were then injection-molded at a cylinder temperature of 260° C. and a mold temperature of 80° C. to prepare the ISO 3167 test pieces. The evaluation of the test pieces was conducted in accordance with the evaluation criteria specified by ISO 527-1 and 2.

### <Flowability at Thin-Wall Portion>

The prepared pellets were dried for 3 hours at 140° C., which were then formed to bar-flow molding having a thickness of 0.5 mm and a width of 5 mm. The flowability was determined by the flow length. The injection condition for the evaluation was 260° C. of cylinder temperature, 65° C. of mold temperature, and 70 mm/s of injection speed, with two levels of dwelling (50 MPa and 100 MPa).

TABLE 1

| | Examples | | | | | | | | | | | | Comparative Examples | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 1 | 2 | 3 | 4 |
| (A-1) (parts by weight) | | | | | | | 80 | 80 | 80 | 80 | | | | | | 80 |
| (A-2) (parts by weight) | 80 | 80 | 80 | 70 | 90 | 80 | | | | | 80 | 80 | 100 | 80 | 80 | |
| (B-1) (parts by weight) | 20 | 20 | 20 | 30 | 10 | | 20 | | | 20 | 20 | 20 | | 20 | 20 | 20 |
| (B-2) (parts by weight) | | | | | | 20 | | 20 | | | | | | | | |
| (B-3) (parts by weight) | | | | | | | | | 20 | | | | | | | |
| (C-1) (parts by weight) | 0.2 | 0.5 | 1 | 0.5 | 0.5 | 0.5 | 0.5 | 0.5 | 0.5 | 0.5 | | | 0.5 | | 10 | |
| (C-2) (parts by weight) | | | | | | | | | | | 0.5 | | | | | |
| (C-3) (parts by weight) | | | | | | | | | | | | 0.5 | | | | |
| (D) (parts by weight) | | | | | | | 50 | 50 | 50 | 20 | | | | | | 50 |
| Melt viscosity (Pa · s) | 130 | 120 | 110 | 120 | 125 | 125 | 130 | 135 | 105 | 100 | 125 | 125 | 130 | 165 | — | 155 |
| Tensile strength (MPa) | 45 | 44 | 43 | 30 | 49 | 38 | 147 | 140 | 138 | 105 | 43 | 45 | 58 | 44 | — | 149 |
| Tensile elongation (%) | >80 | >80 | >80 | >80 | >80 | >80 | 2.6 | 2.5 | 2.5 | 3.2 | >80 | >80 | 40 | >80 | — | 2.4 |
| Flow length (mm) | | | | | | | | | | | | | | | | |
| dwelling 50 MPa | 40 | 42 | 44 | 42 | 41 | 41 | 40 | 40 | 45 | 45 | 41 | 41 | 39 | 34 | | 37 |
| dwelling 100 MPa | 58 | 60 | 63 | 60 | 59 | 59 | 58 | 57 | 65 | 66 | 59 | 59 | 57 | 49 | | 51 |

1. A polybutylene terephthalate resin composition, obtained by blending 0.01 to 5 parts by weight of (C) an acrylic-based oligomer to 100 parts by weight of the sum of 50 to 99 parts by weight of (A) a polybutylene terephthalate resin and 1 to 50 parts by weight of (B) a thermoplastic elastomer.

2. The polybutylene terephthalate resin composition according to claim 1, wherein the (B) thermoplastic elastomer is a polyester-based or an olefin-based elastomer.

3. The polybutylene terephthalate resin composition according to claim 1, wherein the (C) acrylic-based oligomer is an oligomer of acrylic acid-based or methacrylic acid-based alkyl ester.

4. The polybutylene terephthalate resin composition according to claim 1, further comprising 10 to 100 parts by weight of (D) an inorganic filler.

5. The polybutylene terephthalate resin composition according to claim 1, wherein the measured melt viscosity thereof is 140 Pa·s or less at a shear rate of 1000 sec⁻¹ at 260° C.

6. A thin-wall molded article composed of the polybutylene terephthalate resin composition according to claim 1, giving a flow length of 40 mm or more at a thickness of 0.5 mm during the injection molding at a cylinder temperature of 260° C. and a mold temperature of 65° C.

7. The thin-wall molded article according to claim 6, wherein a part of the molded article has a portion of 0.5 mm or smaller thickness.

8. The thin-wall molded article according to claim 6, being a switch, a capacitor, a connector, an integrated circuit (IC), a relay, a resistor, a light-emitting diode (LED), a coil bobbin, peripheral devices or housings thereof.

9. The polybutylene terephthalate resin composition according to claim 2, wherein the (C) acrylic-based oligomer is an oligomer of acrylic acid-based or methacrylic acid-based alkyl ester.

10. The polybutylene terephthalate resin composition according to claim 2, further comprising 10 to 100 parts by weight of (D) an inorganic filler.

11. The polybutylene terephthalate resin composition according to claim 3, further comprising 10 to 100 parts by weight of (D) an inorganic filler.

12. The polybutylene terephthalate resin composition according to claim 9, further comprising 10 to 100 parts by weight of (D) an inorganic filler.

13. The polybutylene terephthalate resin composition according to claim 2, wherein the measured melt viscosity thereof is 140 Pa·s or less at a shear rate of 1000 sec⁻¹ at 260° C.

14. The polybutylene terephthalate resin composition according to claim 3, wherein the measured melt viscosity thereof is 140 Pa·s or less at a shear rate of 1000 sec⁻¹ at 260° C.

15. The polybutylene terephthalate resin composition according to claim 4, wherein the measured melt viscosity thereof is 140 Pa·s or less at a shear rate of 1000 sec⁻¹ at 260° C.

16. A thin-wall molded article composed of the polybutylene terephthalate resin composition according to claim 2, giving a flow length of 40 mm or more at a thickness of 0.5 mm during the injection molding at a cylinder temperature of 260° C. and a mold temperature of 65° C.

17. A thin-wall molded article composed of the polybutylene terephthalate resin composition according to claim 3, giving a flow length of 40 mm or more at a thickness of 0.5 mm during the injection molding at a cylinder temperature of 260° C. and a mold temperature of 65° C.

18. A thin-wall molded article composed of the polybutylene terephthalate resin composition according to claim 4, giving a flow length of 40 mm or more at a thickness of 0.5 mm during the injection molding at a cylinder temperature of 260° C. and a mold temperature of 65° C.

19. A thin-wall molded article composed of the polybutylene terephthalate resin composition according to claim 5, giving a flow length of 40 mm or more at a thickness of 0.5 mm during the injection molding at a cylinder temperature of 260° C. and a mold temperature of 65° C.

20. The thin-wall molded article according to claim 7, being a switch, a capacitor, a connector, an integrated circuit (IC), a relay, a resistor, a light-emitting diode (LED), a coil bobbin, peripheral devices or housings thereof.
